(19) United States
(12) Patent Application Publication
(10) Pub. No.: US 2026/0025835 A1
(43) Pub. Date: Jan. 22, 2026

(54) METHOD AND DEVICE FOR RECEIVING DOWNLINK CONTROL INFORMATION (DCI), METHOD AND DEVICE FOR SENDING DCI, AND STORAGE MEDIUM

(71) Applicant: Beijing Xiaomi Mobile Software Co., Ltd., Beijing (CN)

(72) Inventor: Lei WANG, Beijing (CN)

(73) Assignee: Beijing Xiaomi Mobile Software Co., Ltd., Beijing (CN)

(21) Appl. No.: 18/998,403

(22) PCT Filed: Jul. 29, 2022
(86) PCT No.: PCT/CN2022/109247

§ 371 Date: Jan. 24, 2025

(51) Int. Cl. H04W 72/232; H04W 72/1273

(52) U.S. Cl. CPC H04W 72/232; H04W 72/1273

(57) ABSTRACT

A method for receiving downlink control information (DCI), including: determining first resource ranges corresponding to a serving cell; determining a size corresponding to multi-cell downlink control information (MC-DCI) based on a DCI alignment operation performed in each of the first resource ranges; and receiving and parsing the MC-DCI based on the size.

### CROSS-REFERENCE

The present application is a U.S. National Stage of International Application No. PCT/CN2022/109247, filed on Jul. 29, 2022, the contents of which are incorporated herein by reference in their entirety for all purposes.

### BACKGROUND OF THE INVENTION

The New Radio (NR) technology of the 5^{th} Generation Mobile Communication Technology (5G) operates within a relatively wide spectrum range. With re-farming of a corresponding frequency domain band of an existing cellular network, a utilization rate of a corresponding spectrum will be steadily increased. However, for Frequency Range 1 (FR1), available frequency domain resources are gradually fragmentized. In order to meet various spectrum demands, it is required to utilize such disperse spectrum resources with higher efficiency for spectrum and power and in a more flexible manner to achieve a higher network throughput and a good coverage.

### SUMMARY OF THE INVENTION

The present disclosure relates to the field of communication, and in particular to a method and a device for receiving and sending downlink control information (DCI) and a storage medium. A method and device for receiving and sending DCI and a storage medium are provided according to the embodiments of the present disclosure.

According to a first aspect of the embodiments of the present disclosure, a method for receiving downlink control information (DCI) is provided. The method is performed by a terminal and includes: determining first resource ranges corresponding to a serving cell; determining a size corresponding to multi-cell downlink control information (MC-DCI) based on a DCI alignment operation in each of the first resource ranges; and receiving and parsing the MC-DCI based on the size.

According to a second aspect of the embodiments of the present disclosure, a method for receiving DCI is provided. The method is performed by a terminal and includes: determining a first condition associated with a first cell group, where the first cell group includes at least one cell scheduled by multi-cell downlink control information (MC-DCI); determining, in a case where the MC-DCI meets the first condition, a size of the MC-DCI based on a DCI alignment operation in a first cell in the first cell group; and receiving and parsing the MC-DCI in a second cell based on the size.

According to a third aspect of the embodiments of the present disclosure, a method for sending DCI is provided. The method is performed by a base station and includes: determining first resource ranges corresponding to a serving cell and multi-cell downlink control information (MC-DCI) corresponding to the first resource ranges; performing a DCI alignment operation in each of the first resource ranges and determining a size of the MC-DCI; and sending the MC-DCI to a terminal based on the size.

According to a fourth aspect of the embodiments of the present disclosure, a non-transitory computer-readable storage medium is provided. The non-transitory computer-readable storage medium stores a computer program for performing any of the methods for receiving the DCI at a terminal side.

According to a fifth aspect of the embodiments of the present disclosure, a non-transitory computer-readable storage medium is provided. The non-transitory computer-readable storage medium stores a computer program for performing any of the methods for sending the DCI at base station side.

According to a sixth aspect of the embodiments of the present disclosure, a device for receiving DCI is provided, including: one or more processors; and a memory that stores processor-executable instructions; where the one or more processors are collectively configured to execute the processor-executable instructions to cause the electronic device to act as a terminal and perform any of the methods for receiving the DCI at a terminal side.

According to a seventh aspect of the embodiments of the present disclosure, an electronic device is provided, including: one or more processors; and a memory that stores processor-executable instructions; where the one or more processors are collectively configured to execute the processor-executable instructions to cause the electronic device to act as a base station and perform any of the methods for sending the DCI at a base station side.

It should be understood that both the above general description and the following detailed description are illustrative and explanatory only, which does not limit the present disclosure.

### BRIEF DESCRIPTION OF DRAWINGS

The accompanying drawings, which are incorporated in and constitute a part of this specification, illustrate the embodiments consistent with the present disclosure and together with the description, serve to explain the principles of the present disclosure.

FIG. 1 is a schematic diagram of a physical downlink shared channel (PDSCH) scheduled by single downlink control information (DCI) for a plurality of cells according to an example.

FIG. 2A is a schematic flowchart of a method for receiving DCI according to an example.

FIG. 2B is a schematic diagram of first resource ranges according to an example.

FIG. 2C is a schematic diagram of first resource ranges according to another example.

FIG. 3 is a schematic flowchart of a method for receiving DCI according to another example.

FIG. 4 is a schematic flowchart of a method for receiving DCI according to another example.

FIG. 5 is a schematic flowchart of a method for sending DCI according to another example.

FIG. 6 is a schematic flowchart of a method for sending DCI according to another example.

FIG. 7 is a schematic flowchart of a method for sending DCI according to another example.

FIG. 8A is a schematic diagram of first resource ranges according to another example.

FIG. 8B is a schematic diagram of first resource ranges according to another example.

FIG. 9 is a schematic diagram of the number of cells scheduled by multi-cell DCI (MC-DCI) according to an example.

FIG. 10 is a schematic diagram of the number of cells scheduled by MC-DCI according to another example.

FIG. 11 is a block diagram of a device for receiving DCI according to an example.

FIG. 12 is a block diagram of a device for receiving DCI according to another example.

FIG. 13 is a block diagram of a device for receiving DCI according to another example.

FIG. 14 is a block diagram of a device for sending DCI according to an example.

FIG. 15 is a block diagram of a device for sending DCI according to another example.

FIG. 16 is a block diagram of a device for sending DCI according to another example.

FIG. 17 is a structural schematic diagram of a device for receiving DCI according to an example of the present disclosure.

FIG. 18 is a structural schematic diagram of a device for sending DCI according to an example of the present disclosure.

### DETAILED DESCRIPTION OF THE INVENTION

Illustration will be made in detail here to the examples, and the examples are expressed in the accompanying drawings. The following description refers to the accompanying drawings, unless otherwise indicated, like reference numerals in different accompanying drawings indicate the same or similar elements. The implementations described in the following examples do not represent all the implementations consistent with the present disclosure. Rather, they are merely examples of apparatuses and methods consistent with some of the aspects of the present disclosure as detailed in the appended claims.

The terminologies used in the present disclosure is merely for the purpose of describing particular embodiments and are not intended to limit the present disclosure. Singular forms such as “a”, “said” and “the” as used in the present disclosure and the appended claims are also intended to include plural forms, unless otherwise indicated by the context clearly. It should also be understood that the terminology of “and/or” as used herein refers to and includes any or all possible combinations of at least one associated listed item.

Although terminologies such as first, second, third, etc. may be employed to describe various information in the present disclosure, such information should not be limited to such terminologies. Such terminologies are only used to distinguish the same type of information from each other. For example, without departing from the scope of the present disclosure, first information may also be called second information, and similarly, second information may also be called first information. Depending on the context, the word of “if” as used herein can be interpreted as “when” or “while” or “in response to determining”.

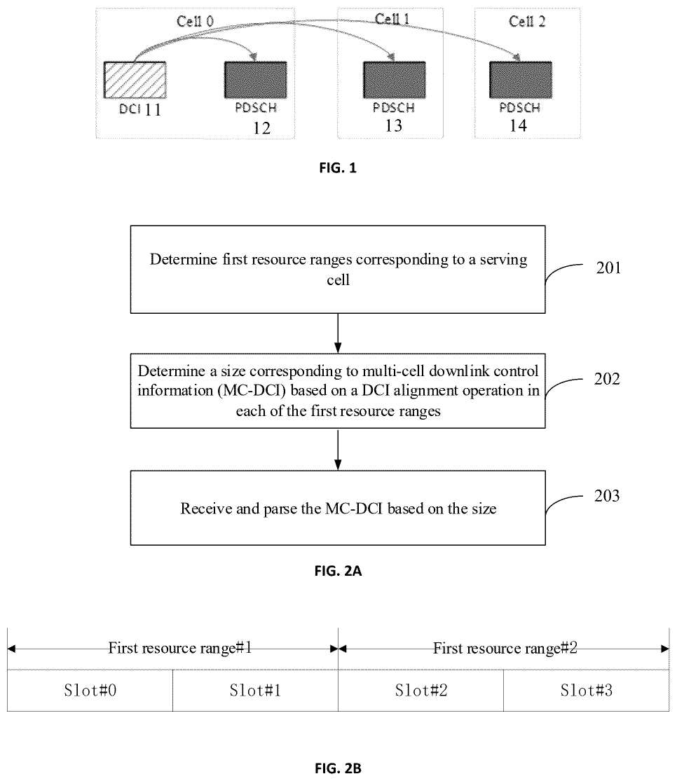

Based on a related mechanism, one piece of downlink control information (DCI) within a scheduling cell is only allowed to schedule data transmission of one cell, i.e., only a physical uplink shared channel (PUSCH) or physical downlink shared channel (PDSCH) of one cell is allowed to be scheduled. With the gradual fragmentization of frequency resources, the demand for scheduling data of a plurality of cells simultaneously will gradually increase. Meanwhile, in order to reduce an overhead of control signaling, Rel-18 WID supports the PDSCH or the PUSCH for which single DCI schedules a plurality of cells. It should be noted that each of the cells corresponds to one PDSCH and one PUSCH. The PDSCH 12, 13, 14 scheduling 3 cells, i.e., cell 0, cell 1, and cell 2 through one piece of DCI 11 can be shown in FIG. 1, for example.

In this scenario, due to factors such as a dynamic change in the number of scheduling cells and supplementary uplink (SUL) characteristics, a gap in the number of bits occupied by multi-cell scheduling downlink control information (mc scheduling DCI) in the serving cell is significant. In the subsequent embodiments, the mc scheduling DCI is represented by MC-DCI. The case that the MC-DCI may correspond to a plurality of sizes will be introduced below with the MC-DCI being defined by the new DCI format as an example (DCI format 0_3: PUSCH for scheduling a plurality of cells; and DCI format 1_3: PDSCH for scheduling a plurality of cells).

For example, some of the DCI fields in DCI format 0_3 and DCI format 1_3 (e.g., transport block (TB) related field) may need to indicate information of different cells in a separate manner. In this case, the separate manner means that different scheduled cells indicate corresponding cell information through different TB fields. Under the condition that the number of cells scheduled by the DCI format 0_3 and DCI format 1_3 changes dynamically, or a plurality of the DCI format 0_3 and/or DCI format 1_3 schedule a current serving cell, MC-DCI corresponding to a plurality of sizes may be configured in the serving cells.

For example, in a case where the plurality of scheduled cells correspond to the DCI format 0_3 support the SUL characteristics, the corresponding BWPs transmitted on a SUL or a non-supplementary uplink (NSUL) by the PUSCHs of different scheduled cells are different, leading to DCI format 0_3 corresponds to a plurality of sizes.

The MC-DCI corresponds to a plurality of sizes, which would increase a budget of the DCI size and improve complexity of blind decoding at the terminal.

In a related mechanism, corresponding to a same DCI format, for example, DCI 0_1 and DCI 0_2, in a case where the terminal supports the SUL characteristics in the serving cell and the DCI size corresponding to the SUL is different from the DCI size corresponding to non-SUL, then alignment of the DCI 0_1 or DCI 0_2 corresponding to the SUL and the NSUL is implemented by mean of zero padding. In other words, alignment of DCI 0_1 or DCI 0_2 corresponding to the SUL and the NSUL is implemented by padding with zero bits. Indeed, in the related mechanism, DCI alignment may also be implemented by means of truncation.

For the MC-DCI, based on the above conditions, the number of DCI sizes corresponding to the same format condition increases, and the gap in size increases. In a case where alignment of the DCI sizes is simply implemented by zero padding, the DCI size will be significantly increased, and the transmission performance of the PDCCH is compromised.

Based on associated mechanisms, one piece of DCI within an existing serving cell is only allowed to schedule data of one cell. With the gradual fragmentization of the frequency resources, the demand for scheduling data of a plurality of cells simultaneously will gradually increase. Therefore, it is required to introduce DCI for scheduling data of a plurality of cells.

In a Release-18 (Rel-18) scenario, single DCI may schedule three or more cells simultaneously. Since multi-cell scheduling DCI corresponds to a plurality of sizes, this increases the blind decoding complexity at the terminal. Meanwhile, when the base station performs DCI alignment operations, the number of zero bits padded in the DCI increases, leading to an enlarged DCI size, which in turn compromises the transmission performance of the Physical Downlink Control Channel (PDCCH).

In order to overcome the problems existing in the related art, a method and device for receiving and sending DCI and a storage medium are provided according to the embodiments of the present disclosure.

The present disclosure provides a method for receiving and sending DCI, which can effectively reduce the number of the zero bits added in the DCI alignment process, weaken the complexity of blind decoding at the terminal, and improve the transmission performance of the PDCCH.

Next, the method for receiving the DCI provided by the present disclosure will be introduced from the terminal side.

In method 1, the terminal deduces a DCI alignment operation in each of first resource ranges, and determines the size of the MC-DCI.

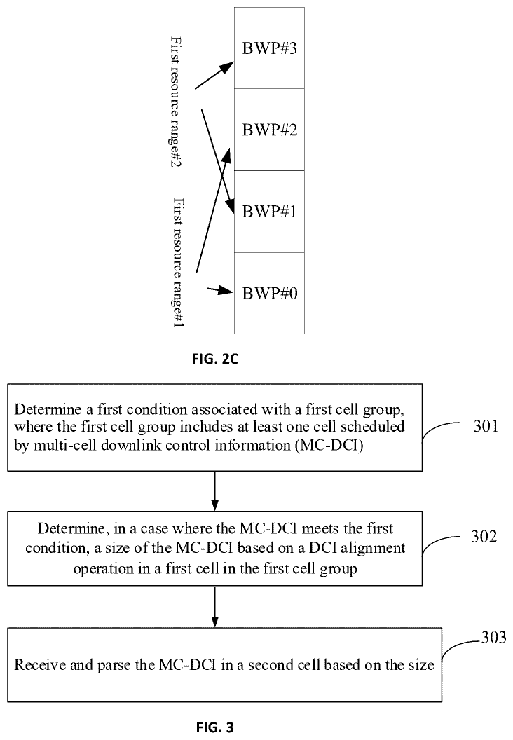

A method for receiving DCI is provided according to an embodiment of the present disclosure. Referring to FIG. 2A, FIG. 2A is a flowchart of a method for receiving the DCI according to an embodiment, in which the method may be performed by a terminal, and may include steps as follows.

In step 201, first resource ranges corresponding to a serving cell are determined.

In the embodiment of the present disclosure, the number of serving cells may be one or more.

In one possible implementation, in a carrier aggregation (CA) scenario, the number of the serving cells corresponding to the terminal may be a plurality of serving cells serving cells, and each of the serving cells may determine a corresponding first resource range, respectively.

In one possible implementation, the first resource range corresponding to the serving cell may include at least one starting resource element identity and the number of continuous resource elements corresponding to each starting resource element identity.

In this case, the starting resource element may be a starting time domain resource element and/or a starting frequency domain resource element, which is not limited by the present disclosure. Additionally, the continuous resource elements may be continuous time domain resource elements and/or continuous frequency domain resource elements, which is also not limited by the present disclosure.

In this case, the first resource range may be consecutive or non-consecutive in a time domain and/or a frequency domain, which is also not limited by the present disclosure. For example, the first resource range is non-consecutive in the time domain, where the first resource range #1 corresponding to the serving cell includes slot #0 and slot #2, the first resource range #2 corresponding to the serving cell includes slot #4 and slot #6, and so on. For another example, the first resource range is consecutive in the time domain, where the first resource range #1 corresponding to the serving cell includes slot #0 and slot #1, the first resource range #2 corresponding to the serving cell includes slot #2 and slot #3, and so on.

In another possible implementation, the first resource range corresponding to the serving cell may include a resource element identity set. Similarly, the resource element may be a time domain resource element and/or a frequency domain resource element, which is not limited by the present disclosure. Additionally, the first resource range may be consecutive or non-consecutive in the time domain and/or the frequency domain, which is also not limited by the present disclosure.

In one possible implementation, the resource element identity set may include, but is not limited to, at least one of the following: a search space (SS) identity set; a bandwidth part (BWP) identity set; or a control-resource set (CORESET) identity set.

Preferably, the resource element identity set may include the SS identity set. For example, the first resource ranges corresponding to the serving cell are SS #1 and SS #3. Accordingly, the terminal subsequently deduces a DCI alignment operation in SS #1 and determines a size of MC-DCI in SS #1, and deduces a DCI alignment operation in SS #3 and determines a size of MC-DCI in SS #3.

In one possible implementation, the above first resource range may be a time domain resource range and/or a frequency domain resource range.

In one possible implementation, the first resource range may be agreed by a protocol, or the first resource range may be configured by a base station through signaling, which is not limited by the present disclosure.

For example, the first resource range may be a time domain resource range, and for example, the time domain resource range may be in the unit of frame, slot, symbol, or the like.

For example, the first resource range corresponding to the serving cell is in the unit of slot. A starting slot of each of the first resource ranges and the number of slots that are included in each of the first resource ranges may be determined for the serving cell by agreement via the protocol, or by being configured through the signaling sent by the base station. For example, an index value of the starting slot is even, and each of the first resource ranges includes 2 slots, as shown in FIG. 2B. The first resource ranges of the serving cell are consecutive in the time domain, where the first resource range #1 corresponding to the serving cell includes slot #0 and slot #1, and the first resource range #2 corresponding to the serving cell includes slot #2 and slot #3, and so on.

For example, the first resource range may be a frequency domain resource range, and for example, the frequency domain resource range may be in a unit of BWP, component carrier (CC) or frequency band.

For example, the first resource range corresponding to the serving cell are in the unit of BWP. An index value of the BWP included in each of the first resource ranges of the serving cell may be determined by agreement via the protocol, or by being configured through the signaling sent by the base station. The first resource ranges of the serving cell may be non-consecutive in the frequency domain, as shown in FIG. 2C, where the first resource range #1 corresponding to the serving cell includes {BWP #0, BWP #2}, while the first resource range #2 corresponding to the serving cell includes {BWP #1, BWP #3}, and so on.

The above is only an illustration. The first resource range may also be the time domain resource range and the frequency domain resource range, which is not limited by the present disclosure.

In step 202, a size corresponding to multi-cell downlink control information (MC-DCI) is determined based on a DCI alignment operation performed in each of the first resource ranges.

In the embodiment of the present disclosure, the MC-DCI is used to schedule data transmission of a plurality of cells. The data transmission of each of the cells corresponds to one physical downlink shared channel (PDSCH) and/or one physical uplink shared channel (PUSCH).

In the related art, the DCI alignment operation is performed by the base station, and the base station performs the DCI alignment operation per scheduled cell, including, but not limited to, performing the DCI alignment operation based on the time-frequency resources of this cell, and performing DCI alignment through zero padding or other means such as truncation for the number of DCI formats and the number of DCI sizes configured for the entire cell. For example, the base station determines that the DCI in a certain format after alignment needs to occupy n1 bits, and the size of the DCI determined by the base station is n2 bits, where n2 is less than n1. In this case, the base station may increase the size of the DCI to n1 by padding with the zero bits. For another example, the base station determines that the DCI in a certain format after alignment needs to occupy n1 bits, and the size of the DCI determined by the base station is n2 bits, where n2 is greater than n1. In this case, the base station may reduce the number of bits of the DCI to n1 by truncation.

For the terminal, it may receive the radio resource control (RRC) signaling sent by the base station to determine the DCI format, DCI size, and other information that may require blind decoding. Based on the DCI format, DCI size, and other information that may require blind decoding, the terminal deduces the DCI alignment operation to determine the actual size of the DCI, thereby enabling it to receive and parse the DCI.

In the related art, the limitation on DCI size is based on per cell. In other words, the DCI alignment operation is performed within each of the serving cells, where 3+1 restriction is required to be met. The 3+1 restriction specifies that the number of types of the DCI sizes scrambled by a cell-radio network temporary identifier (C-RNTI) within the serving cell is no more than 3, and the total number of types of the DCI sizes configured within the serving cell is no more than 4.

However, in the embodiment of the present disclosure, the base station side may perform the DCI alignment operation within a plurality of serving cells scheduled by the MC-DCI, or may also perform the DCI alignment operation within one of the plurality of serving cells scheduled by the MC-DCI, which is not limited by the present disclosure.

The terminal side deduces the DCI alignment operation in each of the first resource ranges within the serving cell, and the size of the DCI in each of the first resource ranges may meet the 3+1 restriction or other restriction in the related art. By deducing the DCI alignment operation in each of the first resource ranges, the terminal determines the size corresponding to the MC-DCI, to parse and receive the MC-DCI based on the size of the MC-DCI.

In the embodiment of the present disclosure, for the terminal in each of the first resource ranges of the serving cell, other restriction that the size of the DCI meets may be 4+1, or a DCI size restriction agreed by a protocol, which is not limited by the present disclosure.

In the embodiment of the present disclosure, performing the DCI alignment operation by the base station side for the MC-DCI in each of the first resource ranges means that the base station aligns, in each of the first resource ranges, the size before MC-DCI alignment with the size after MC-DCI alignment through zero padding or other means such as length truncation.

In step 203, the MC-DCI is received and parsed based on the size.

In the above embodiment, in contrast to that the terminal deduces the DCI alignment operation per cell, in the present disclosure, the terminal may deduce the DCI alignment operation in a smaller first resource range. It can be understood that the smaller the resource range, the less the number of formats and sizes of the DCI that the terminal side may require to perform blind decoding, thereby effectively reducing complexity of blind decoding at the terminal and improving transmission performance of the PDCCH.

In some alternative embodiments, the first resource ranges corresponding to the serving cell may be determined in the following manners.

Manner 1: determining the first resource ranges based on at least one starting resource element identity and the number of the continuous resource elements corresponding to each starting resource element identity.

In this case, the starting resource element may be a starting time domain resource element and/or a starting frequency domain resource element, which is not limited by the present disclosure. Additionally, the number of the continuous resource elements may be a continuous time domain resource element and/or continuous frequency domain resource element, which is also not limited by the present disclosure. In this case, the first resource range may be consecutive or non-consecutive in the time domain and/or the frequency domain, which is also not limited by the present disclosure.

Manner 2: determining the first resource ranges based on a resource element identity set.

In the embodiment of the present disclosure, the first resource range may be a segment of consecutive time domain resource, or one or more segments of non-consecutive time domain resources, and/or the first resource range may be a segment of consecutive frequency domain resource, or one or more segments of non-consecutive frequency domain resources, which is not limited by the present disclosure.

The resource element identity set may include, but is not limited to, at least one of the following: a SS identity set; a BWP identity set; a control resource set (CORESET) identity set. Preferably, the resource element identity may include a SS identity set.

The above first resource range may be agreed by the protocol, or configured by a base station through signaling, which is not limited by the present disclosure.

In the above embodiment, the first resource ranges corresponding to the serving cell may be determined in the above manner. This enables the terminal to deduce the DCI alignment operation within each first resource range, thereby determining the size of the MC-DCI. In this way, the blind decoding complexity of the terminal is reduced and the PDCCH transmission performance is effectively improved.

In some alternative embodiments, in a case where any two pieces of the MC-DCI correspond to different formats, the terminal is not expected to determine the sizes corresponding to the two pieces of the MC-DCI in the same first resource range.

In a case where the terminal may need to perform blind decoding on two pieces of the MC-DCI in different formats, the terminal needs to deduce DCI alignment operations in different first resource ranges, to determine the sizes of the two pieces of the MC-DCI. In other words, the terminal is not expected to determine the sizes corresponding to the two pieces of the MC-DCI in the same first resource range.

In the above embodiment, the MC-DCI in different formats is isolated through different the first resource ranges, which reduces the complexity of blind decoding at the terminal and effectively improves the transmission performance of the PDCCH.

In some alternative embodiments, in a case where any two pieces of the DCI correspond to different sizes before the DCI alignment operation, the terminal is not expected to determine the sizes corresponding to the two pieces of the MC-DCI in the same first resource range.

It should be noted that the terminal can receive the RRC signaling sent by the base station, to determine the DCI formats on which the terminal may perform blind decoding based on the RRC signaling. Based on the network side configuration, the terminal may determine the MC-DCI formats on which blind decoding may be performed, the size before MC-DCI alignment and the size after MC-DCI alignment.

In the embodiment of the present disclosure, in a case where the terminal determines that two pieces of the DCI correspond to different sizes before the DCI alignment operation, the terminal needs to deduce DCI alignment operations in different first resource ranges, to determine the sizes of the two pieces of the MC-DCI. In other words, the terminal is not expected to determine the sizes corresponding to the two pieces of the MC-DCI in the same first resource range.

In the above embodiment, the MC-DCI with different sizes before the DCI alignment operation are isolated through different first resource ranges, which can weaken the complexity of blind decoding at the terminal and effectively improve the transmission performance of the PDCCH.

In method 2, for the MC-DCI that corresponds to different sizes before the DCI alignment, the DCI alignment operations in the cells are deduced in different cell groups.

According to an embodiment of the present disclosure, a method for receiving DCI is provided. Referring to FIG. 3, FIG. 3 is a flowchart of a method for receiving DCI according to an embodiment, in which the method may be performed by a terminal, and may include steps as follows.

In step 301, a first condition associated with a first cell group is determined, where the first cell group includes at least one cell that can (is able to) be scheduled by multi-cell downlink control information (MC-DCI).

In the embodiment of the present disclosure, the MC-DCI is used to schedule data transmission of a plurality of cells, where the data transmission of each of the cells corresponds to one PDSCH and/or one PUSCH.

In the embodiment of the present disclosure, the cells that can be scheduled by the MC-DCI refer to the cells simultaneously scheduled by the MC-DCI, i.e., the plurality of cells scheduled by the MC-DCI in real time. Or, the cells that can be scheduled by the MC-DCI refer to one or more cells scheduled by the MC-DCI at different moments, but not necessarily the cells scheduled by the MC-DCI at a current moment. The cell set that can be scheduled by the MC-DCI may be determined through RRC signaling, or through a predefined manner, which is not limited by the present disclosure.

For example, the cell set that can be scheduled by the MC-DCI includes cell #1, cell #2 and cell #3. At moment t1, the data transmission of cell #1 and cell #2 is scheduled by the MC-DCI; and at moment t2, the data transmission of cell #1 and cell #3 is scheduled by MC-DCI.

The first cell group includes at least one cell that can be scheduled by the MC-DCI. For example, the cells that can be scheduled by the MC-DCI refer to one or more cells scheduled by the MC-DCI at different moments. The first cell group #1 includes cell #1 and cell #2, and the first cell group #2 includes cell #3.

In the embodiment of the present disclosure, different first conditions may be associated with different first cell groups. For example, the first condition is the maximum number of cells that can be supported by the MC-DCI for simultaneous scheduling. The maximum number of cells that can be supported by the MC-DCI for simultaneous scheduling in the first cell group #1 is 2, and the maximum number of cells that can be supported by the MC-DCI for simultaneous scheduling in the first cell group #2 is 3.

In one possible implementation, the first condition may be at least one of the following: the maximum number of cells that can be supported by the MC-DCI for simultaneous scheduling; the number of cells simultaneously scheduled by the MC-DCI; the maximum number of cells that support SUL characteristics among a plurality of cells that can be scheduled by the MC-DCI; and a maximum number of cells that do not support the SUL characteristics among the plurality of cells that can be scheduled by the MC-DCI.

In this case, the maximum number of the cells that can be supported by the MC-DCI for simultaneous scheduling may refer to the maximum number of cells that can be simultaneously scheduled by the MC-DCI at any moment. The number of cells simultaneously scheduled by the MC-DCI may refer to the number of cells simultaneously scheduled by the MC-DCI at any moment, and the number of cells is less than or equal to the above maximum number of the cells. The cells that can be scheduled by the MC-DCI refer to the cells simultaneously scheduled by the MC-DCI, i.e., the plurality of cells scheduled by the MC-DCI in real time. Or, the cells that can be scheduled by the MC-DCI refer to one or more cells scheduled by the MC-DCI at different moments, but not necessarily the cells scheduled by the MC-DCI at the current moment.

For example, for the first cell group #1, the number of cells that can be simultaneously scheduled by the configured MC-DCI, as supported by the first cell group #1, is equal to N.

For another example, for N′ first cell groups, the number of cells that can be simultaneously scheduled by the configured MC-DCI, as supported by the N′ first cell groups, corresponds to N′ sets. The number of cells that can be simultaneously scheduled by the configured MC-DCI, as supported by the n-th first cell group, is from the n-th set among the N′ sets, where the n-th set may include one or more sets from the N′ sets.

In one possible implementation, the first condition may be agreed by a protocol, or configured by a base station through signaling, which is not limited by the present disclosure.

In the embodiment of the present disclosure, it may be agreed by the protocol that the maximum number of cells that can be supported by the MC-DCI for simultaneous scheduling in three of the first cell groups is two, respectively set 1 and set 2. The first cell group #1 determines that the maximum number of the cells that can be supported by the MC-DCI for simultaneous scheduling comes from set 1, and the first cell group #2 determines that the maximum number of the cells that can be supported by the MC-DCI for simultaneous scheduling comes from set 2.

The above is only an exemplary illustration, and the first conditions corresponding to different first cell groups may be agreed by the protocol, and/or configured by the base station through the signaling, which will not be detailed here.

In step 302, when the MC-DCI meets the first condition, the size of the MC-DCI is determined based on a DCI alignment operation in a first cell within the first cell group.

In the embodiment of the present disclosure, in a case where the MC-DCI meets the first condition corresponding to the first cell group, the terminal may deduce the DCI alignment operation in the first cell with the first cell group, to determine the size of the MC-DCI.

For example, the first condition is the maximum number of the cells that can be supported by the MC-DCI for simultaneous scheduling. The first condition associated with the first cell group #1 indicates that the maximum number of the cells is 2, while the first condition associated with the first cell group #2 indicates that the maximum number of the cells is 3. Then the terminal determines, based on RRC signaling sent by a base station side and in response to determining the MC-DCI can simultaneously schedule data transmission for three cells, that the first cell in the first cell group #2 deduces the DCI alignment operation, and determines the size of the MC-DCI.

In one possible implementation, when the number of cells that are included in the first cell group is multiple, the first cell is the cell with the largest or smallest cell index value in the first cell group.

For example, in the above embodiment, the terminal determines to deduce the DCI alignment operation in a first cell in the first cell group #2, and determines the size of the MC-DCI. The first cell group #2 includes cell #2, cell #4 and cell #5, then the terminal may deduce the DCI alignment operation in cell #2, or the terminal may deduce the DCI alignment operation in cell #5.

In the embodiment of the present disclosure, selection of the cell with the largest or smallest cell index value may be agreed by the protocol, or configured by the base station side through signaling, which is not limited by the present disclosure.

It should also be noted that in the embodiment of the present disclosure, the terminal performs the DCI alignment operation in the serving cell, and the size of the MC-DCI can meet a 3+1 restriction in the related art. Indeed, the DCI size restriction may also be 4+1, or other DCI size restriction(s) agreed by the protocol, which is not limited by the present disclosure.

In the embodiment of the present disclosure, performing the DCI alignment operation by the base station side means that the base station aligns, for the MC-DCI, the size before MC-DCI alignment with the size after MC-DCI alignment through zero padding or other means such as length truncation.

In step 303, the MC-DCI is received and parsed in a second cell based on the size.

In the embodiment of the present disclosure, after determining the size of the MC-DCI, the terminal side may detect and receive the MC-DCI in the second cell, which may be any cell in the first cell group, i.e., the second cell may be the first cell or any cell in the first cell group other than the first cell. Or, the second cell may be independent of the first cell group, i.e., the second cell may be any cell that is different from the first cell group, which is not limited by the present disclosure.

In the above embodiment, when the MC-DCI meets the first condition associated with the first cell group, the terminal may deduce the DCI alignment operation in the first cell within the first cell group, determine the size of the MC-DCI, which reduces the complexity of blind decoding at the terminal, and effectively improves the transmission performance of the PDCCH.

In method 3, the first size corresponding to the MC-DCI in each format is directly determined based on a predefined manner or an indication of signaling by the base station side.

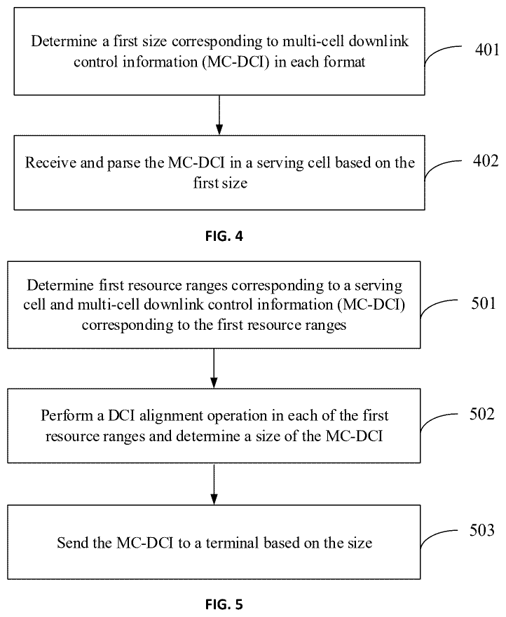

A method for receiving DCI is provided according to an embodiment of the present disclosure. Referring to FIG. 4, FIG. 4 is a flowchart of a method for receiving DCI according to an embodiment, in which the method may be performed by a terminal, and may include steps as follows.

In step 401, a first size corresponding to multi-cell downlink control information (MC-DCI) in each format is determined.

In the embodiment of the present disclosure, the MC-DCI is used to schedule data transmission of a plurality of cells, and the data transmission of each of the cells corresponds to one PDSCH and/or one PUSCH.

In one possible implementation, the first size corresponding to the MC-DCI in each format is determined based on an indication of signaling sent by a base station.

Optionally, when dynamic switching of the number of cells simultaneously scheduled by the MC-DCI is supported, a first size corresponding to the MC-DCI in each format may be determined based on the indication of the signaling sent by the base station.

Optionally, when dynamic switching of the number of the cells simultaneously scheduled by the MC-DCI is not supported, the first size corresponding to the MC-DCI in each format may also be determined based on the indication of the signaling sent by the base station. For example, the base station sends to the terminal RRC signaling, through which it is indicated that the first size corresponding to MC-DCI format 0_3 is size #1 (in a case where n1 bits are occupied), and the first size corresponding to MC-DCI format 1_3 is size #2 (in a case where n2 bits are occupied).

In another possible implementation, the terminal may determine the first size corresponding to the MC-DCI in each format based on a predefined manner, such as agreement by a protocol.

Optionally, when dynamic switching of the number of the cells simultaneously scheduled by the MC-DCI is supported, the terminal may determine the first size corresponding to the MC-DCI in each format based on agreement by the protocol.

Optionally, when dynamic switching of the number of the cells simultaneously scheduled by the MC-DCI is not supported, the terminal may also determine the first size corresponding to the MC-DCI in each format based on agreement by the protocol.

For example, the protocol agrees that the size corresponding to the MC-DCI format 0_3 is size #1, and the size corresponding to the MC-DCI format 1_3 is size #2.

In the embodiment of the present disclosure, the terminal may determine the DCI format on which the terminal might perform blind decoding through the RRC signaling sent by a base station. In a case where the MC-DCI formats on which blind decoding may be performed are 0_3 and 1_3, the terminal may determine the first sizes corresponding to the MC-DCI in formats 0_3 and 1_3 respectively based on the predefined manner or the indication of signaling sent by the base station.

In step 402, the MC-DCI is received and parsed in a serving cell based on the first size.

In the embodiment of the present disclosure, the terminal receives and parses the MC-DCI in the serving cell according to the first size determined in the above step 401.

It should also be noted that in the embodiment of the present disclosure, the size of the MC-DCI needs to meet a 3+1 restriction. Indeed, the DCI size restriction may also be 4+1, or other defined DCI size restriction, which is not limited by the present disclosure.

In the above embodiment, the terminal may determine the first size corresponding to the MC-DCI in each format based on a predefined manner or an indication of signaling sent by a base station, and receive and parse the MC-DCI. By reducing the number of sizes of the MC-DCI in the same format, the complexity of blind decoding at the terminal is effectively reduced and the transmission performance of the PDCCH is effectively improved.

It can be understood that in the present disclosure, the MC-DCI in each format may correspond to a type of first size, and the MC-DCI in each format may correspond to two or more types of first sizes, which should also be within the protection scope of the present disclosure.

In some alternative embodiments, in a case where dynamic switching of the number of the cells simultaneously scheduled by the MC-DCI is supported, the number of the cells simultaneously scheduled by the MC-DCI may be set to two at most.

In other words, the number of the cells simultaneously scheduled by the MC-DCI may be switched between 1 and 2 to reduce the number of the sizes of the MC-DCI in the same format. This helps eliminate the compromise to PDCCH transmission performance that will occur if excessive zero bits are added during the DCI alignment process to align with the first size.

In some alternative embodiments, in a scenario where the maximum number of the cells that can be scheduled by the MC-DCI is Nmax, all cells that can be scheduled by the MC-DCI may not support SUL characteristics. In other words, when determining the size corresponding to each MC-DCI format, there is no need to consider the SUL characteristics to reduce the number of the sizes of the MC-DCI in the same format. This helps eliminate the compromise to PDCCH transmission performance that will occur if excessive zero bits are added during the DCI alignment process to align with the first size.

Or, the number of the cells that support SUL characteristics is set.

In one possible implementation, among all cells that can be scheduled by the MC-DCI, only the cell that receives the MC-DCI may support the SUL characteristics to reduce the number of the sizes of the MC-DCI in the same format. This helps eliminate the compromise to PDCCH transmission performance that will occur if excessive zero bits are added during the DCI alignment process to align with the first size. In another possible implementation, among all cells that can be scheduled by the MC-DCI, the number of the cells that support the SUL characteristics is less than or equal to 2, to reduce the number of the sizes of the MC-DCI in the same format. This helps eliminate the compromise to PDCCH transmission performance that will occur if excessive zero bits are added during the DCI alignment process to align with the first size.

In the embodiment of the present disclosure, the cells that can be scheduled by the MC-DCI refer to the cells simultaneously scheduled by the MC-DCI, i.e., the plurality of cells scheduled by the MC-DCI in real time. Or, the cells that can be scheduled by the MC-DCI refer to one or more cells scheduled by the MC-DCI at different moments, but not necessarily the cells scheduled by the MC-DCI at a current moment.

In the above embodiment, the compromise to PDCCH transmission performance that will occur if excessive zero bits are added during the DCI alignment process to align with the first size is eliminated by reducing the number of the sizes corresponding to MC-DCI in the same format.

In some alternative embodiments, the terminal may determine the first size corresponding to the MC-DCI in each format based on an indication of signaling sent by the base station, or determine the first size corresponding to the MC-DCI in each format based on agreement by the protocol, which is not limited by the present disclosure.

For the base station side, the DCI alignment operation may be performed by zero padding or other means, specifically, the size before MC-DCI alignment may be aligned with the first size after MC-DCI alignment.

Next, the method for sending the DCI provided by the present disclosure will be introduced from the base station side.

In method 1, the base station performs a DCI alignment operation in each of the first resource ranges of the serving cell.

A method for sending DCI is provided according to an embodiment of the present disclosure. Referring to FIG. 5, FIG. 5 is a flowchart of a method for sending DCI according to an embodiment, in which the method may be performed by a base station, and may include steps as follows.

In step 501, first resource ranges corresponding to a serving cell and MC-DCI corresponding to the first resource ranges are determined.

In the embodiment of the present disclosure, the number of serving cells may be one or more.

In one possible implementation, in a CA scenario, the number of the serving cells corresponding to the terminal may be multiple, and each of the serving cells may determine a corresponding first resource range, respectively.

In the embodiment of the present disclosure, the MC-DCI is used to schedule data transmission of a plurality of cells, and the data transmission of each of the cells corresponds to one PDSCH and/or one PUSCH.

In one possible implementation, the first resource ranges corresponding to the serving cell may include at least one starting resource element identity and the number of continuous resource elements corresponding to each starting resource element identity.

In this case, the starting resource element may be a starting time domain resource element and/or a starting frequency domain resource element, which is not limited by the present disclosure. Additionally, the continuous resource element may be a continuous time domain resource element and/or a continuous frequency domain resource element, which is also not limited by the present disclosure.

In this case, the first resource range may be consecutive or non-consecutive in a time domain and/or a frequency domain, which is also not limited by the present disclosure. For example, the first resource range is non-consecutive in the time domain, in which the first resource range #1 corresponding to the serving cell includes slot #0 and slot #2, the first resource range #2 corresponding to the serving cell includes slot #4 and slot #6, and so on. For another example, the first resource range is consecutive in the time domain, in which the first resource range #1 corresponding to the serving cell includes slot #0 and slot #1, the first resource range #2 corresponding to the serving cell includes slot #2 and slot #3, and so on.

In another possible implementation, the first resource ranges corresponding to the serving cell may include a resource element identity set. Similarly, the resource element may be a time domain resource element and/or a frequency domain resource element, which is not limited by the present disclosure. Additionally, the first resource range may be consecutive or non-consecutive in the time domain and/or the frequency domain, which is also not limited by the present disclosure.

In one possible implementation, the resource element identity set may include, but is not limited to, at least one of the following: a SS identity set; a BWP identity set; or a CORESET identity set.

Preferably, the resource element identity set may include a SS identity set. For example, the first resource ranges corresponding to the serving cell are SS #1 and SS #3. Accordingly, the terminal subsequently deduces a DCI alignment operation in SS #1 and determines a size of the MC-DCI in SS #1, and deduces a DCI alignment operation in SS #3 and determines a size of the MC-DCI in SS #3.

In one possible implementation, the above first resource range may be a time domain resource range and/or a frequency domain resource range.

In one possible implementation, the first resource range may be agreed by a protocol, or the first resource range may be configured by a base station through signaling, which is not limited by the present disclosure.

For example, the first resource range may be a time domain resource range, and for example, the time domain resource range may be in the unit of frame, slot, symbol, or the like.

For example, the first resource range corresponding to the serving cell is in the unit of slot. A starting slot of each of the first resource ranges and the number of slots that are included in each of the first resource ranges may be determined for the serving cell by means of agreement via the protocol, or by means of being configured through the signaling sent by the base station. For example, an index value of the starting slot is even, and each of the first resource ranges includes 2 slots, as shown in FIG. 2B. The first resource ranges of the serving cell are consecutive in the time domain, where the first resource range #1 corresponding to the serving cell includes slot #0 and slot #1, and the first resource range #2 corresponding to the serving cell includes slot #2 and slot #3, and so on.

For example, the first resource range may be a frequency domain resource range, and for example, the frequency domain resource range may be in a unit of BWP, CC or frequency band.

For example, the first resource ranges corresponding to the serving cell are in the unit of BWP. An index value of the BWP included in each of the first resource ranges of the serving cell may be determined by means of agreement by the protocol, or by means of being configured through the signaling sent by the base station. The first resource ranges of the serving cell may be non-consecutive in the frequency domain, as shown in FIG. 2C, where the first resource range #1 corresponding to the serving cell includes {BWP #0, BWP #2}, while the first resource range #2 corresponding to the serving cell includes {BWP #4, BWP #6}, and so on.

The above is only an illustration. The first resource range may also be a time domain resource range and a frequency domain resource range, which is not limited by the present disclosure.

In step 502, a DCI alignment operation is performed in each of the first resource ranges, and the size of the MC-DCI is determined.

In the related art, the DCI alignment operation and the restriction of the size of the DCI are based on per scheduled cell, i.e., the DCI alignment operation is performed in each of the serving cells, where a 3+1 restriction is required to be met. In the present disclosure, the base station performs the DCI alignment operation in each of the first resource ranges of the serving cell, and a size of the DCI in each of the first resource ranges meets the 3+1 restriction or other restriction, to determine the size corresponding to the MC-DCI.

In the embodiment of the present disclosure, the size of the MC-DCI in each of the first resource ranges meeting the 3+1 restriction means that the number of types of the DCI sizes scrambled by C-RNTI configured in each of the first resource ranges of the serving cell is no more than 3, and a total number of types of the DCI sizes configured in each of the first resource ranges of the serving cell is no more than 4.

In the embodiment of the present disclosure, the DCI size restriction in each of the first resource ranges of the serving cell may also be 4+1, or other defined DCI size restriction(s), which is not limited by the present disclosure.

In the embodiment of the present disclosure, performing the alignment operation by the base station in each of the first resource ranges means that the base station aligns, for the MC-DCI to be sent, the size before MC-DCI alignment with the size after MC-DCI alignment through zero padding or other means such as length truncation.

For example, the size before MC-DCI alignment is n1 bits, and the size after MC-DCI alignment occupies n2 bits, where n2 is greater than n1. Then the base station needs to add a plurality of zero bits based on the size before MC-DCI alignment, until the size of the MC-DCI reaches n2 bits.

For another example, the size before MC-DCI alignment is n1 bits, and the size after MC-DCI alignment occupies n2 bits, where n2 is less than n1. Then the base station needs to truncate the size before MC-DCI alignment so that the size of the MC-DCI reaches n2 bits.

In step 503, the MC-DCI is sent to the terminal based on the size.

In the above embodiment, by the DCI alignment operation is performed in the first resource ranges of the serving cell, the number of bits occupied by the MC-DCI is reduced, the number of zero bits added in the DCI alignment process is reduced, thereby lowering complexity of blind decoding at the terminal and improving PDCCH transmission performance.

In some alternative embodiments, the first resource ranges corresponding to the serving cell may be determined in the following manners.

Manner 1: determining the first resource ranges based on at least one starting resource element identity and the number of continuous resource elements corresponding to each starting resource element identity.

In this case, the starting resource element may be a starting time domain resource element and/or a starting frequency domain resource element, which is not limited by the present disclosure. Additionally, the continuous resource element may be the continuous time domain resource element and/or continuous frequency domain resource element, which is also not limited by the present disclosure. In this case, the first resource range may be consecutive or non-consecutive in a time domain and/or a frequency domain, which is also not limited by the present disclosure.

Manner 2: determining the first resource ranges based on a resource element identity set.

In the embodiment of the present disclosure, the first resource range may be a segment of consecutive time domain resource, or one or more segments of non-consecutive time domain resources, and/or the first resource range may be a segment of consecutive frequency domain resource, or one or more segments of non-consecutive frequency domain resources, which is not limited by the present disclosure.

The resource element identity set may include, but is not limited to, at least one of the following: a SS identity set; a BWP identity set; or a CORESET identity set. Preferably, the resource element identity set may include a SS identity set.

The above first resource range can be agreed by a protocol, or configured by a base station through signaling, which is not limited by the present disclosure.

In the above embodiment, the first resource ranges corresponding to the serving cell may be determined in the above manner to reduce the number of zero bits added during DCI alignment. In this way, the blind decoding complexity at the terminal is reduced and the PDCCH transmission performance is effectively improved.

In some alternative embodiments, in a case where any two pieces of the MC-DCI correspond to different formats, the base station performs, respectively in different first resource ranges, the DCI alignment operations on the two pieces of the MC-DCI. The terminal side deduces DCI alignment operations in different first resource ranges, which further reduces the complexity of blind decoding at the terminal.

In addition/alternatively, in a case where any two pieces of DCI correspond to different sizes before the DCI alignment operation, the base station performs, respectively in different first resource ranges, the DCI alignment operations on the two pieces of the MC-DCI. The terminal side deduces the DCI alignment operations in different first resource ranges, which further reduces the complexity of blind decoding at the terminal.

In the above embodiment, it can also effectively reduce the number of zero bits added in the DCI alignment process, reduce the complexity of blind decoding at the terminal, and effectively improve the transmission performance of the PDCCH.

Method 2: for the MC-DCI that corresponds to different sizes before DCI alignment, performing the DCI alignment operations in the cells in different cell groups.

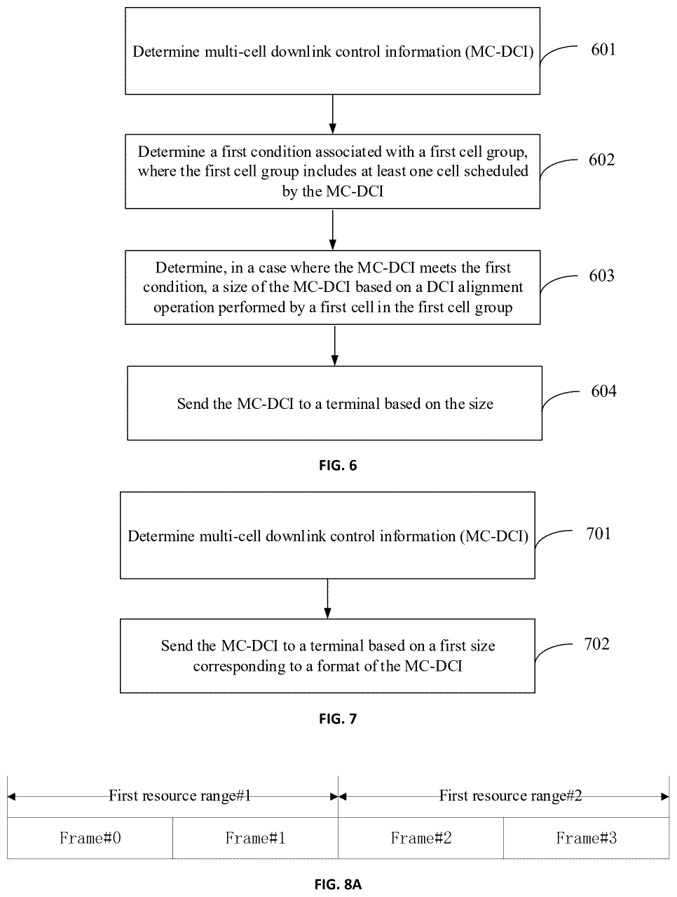

A method for sending DCI is provided according to an embodiment of the present disclosure. Referring to FIG. 6, FIG. 6 is a flowchart of a method for sending DCI according to an embodiment, in which the method may be performed by a base station, and may include steps as follows.

In step 601, multi-cell downlink control information (MC-DCI) is determined.

In the embodiment of the present disclosure, the MC-DCI is used to schedule data transmission of a plurality of cells, and data transmission of each of the cells corresponds to one PDSCH and/or one PUSCH.

In step 602, a first condition associated with a first cell group is determined, where the first cell group includes at least one cell that can be scheduled by the MC-DCI.

In the embodiment of the present disclosure, the cells that can be scheduled by the MC-DCI refer to the cells simultaneously scheduled by the MC-DCI, i.e., the plurality of cells scheduled by the MC-DCI in real time. Or, the cells that can be scheduled by the MC-DCI refer to one or more cells scheduled by the MC-DCI at different moments, but not necessarily the cells scheduled by the MC-DCI at a current moment. The cell set that can be scheduled by the MC-DCI may be determined through RRC signaling, or through a predefined manner, which is not limited by the present disclosure.

In the embodiment of the present disclosure, different first conditions may be associated with different first cell groups.

In one possible implementation, the first condition may be at least one of the following: the maximum number of cells that can be supported by the MC-DCI for simultaneous scheduling; the number of cells simultaneously scheduled by the MC-DCI; the maximum number of cells that support SUL characteristics among a plurality of cells that can be scheduled by the MC-DCI; and the maximum number of cells that do not support the SUL characteristics among the plurality of cells that can be scheduled by the MC-DCI.

In this case, the maximum number of the cells that can be supported by the MC-DCI for simultaneous scheduling may refer to the maximum number of cells that can be simultaneously scheduled by the MC-DCI at any moment. The number of the cells simultaneously scheduled by the MC-DCI may refer to the number of cells simultaneously scheduled by the MC-DCI at any moment, and the number of the cells is less than or equal to the above maximum number of the cells. The cells that can be scheduled by the MC-DCI refer to the cells simultaneously scheduled by the MC-DCI, i.e., the plurality of cells scheduled by the MC-DCI in real time. Or, the cells that can be scheduled by the MC-DCI refers to one or more cells scheduled by the MC-DCI at different moments, but not necessarily the cells scheduled by the MC-DCI at a current moment.

In one possible implementation, the first condition may be agreed by a protocol, or configured by a base station through signaling, which is not limited by the present disclosure.

In step 603, when the MC-DCI meets the first condition, the size of the MC-DCI is determined based on a DCI alignment operation performed by a first cell in the first cell group.

In the embodiment of the present disclosure, if the MC-DCI meets the first condition corresponding to the first cell group, the base station may perform a DCI alignment operation in a first cell in the first cell group, to determine the size of the MC-DCI.

In one possible implementation, when the number of the cells that are included in the first cell group is multiple, the first cell is the cell with the largest or smallest cell index value in the first cell group.

It should also be noted that in a case where the base station performs the DCI alignment operation in the first cell, the size of the MC-DCI is required to meet a preset restriction. Indeed, the preset restriction may be a 3+1 or 4+1 restriction, or other DCI size restriction agreed by the protocol, which is not limited by the present disclosure.

In the embodiment of the present disclosure, performing the alignment operation means that the base station aligns, for the MC-DCI to be sent, the size of the MC-DCI to be sent with a size corresponding to a MC-DCI format through zero padding or other means such as length truncation.

In step 604, the MC-DCI is sent to a terminal based on the size.

In the embodiment of the present disclosure, the base station may be a base station of a second cell, where the second cell may be any cell in the first cell group, i.e., the second cell may be the first cell or any cell in the first cell group that is different from the first cell. Or, the second cell may be independent of the first cell group, i.e., the second cell may be any cell that is different from the first cell group, which is not limited by the present disclosure.

In the above embodiment, when the MC-DCI meets the first condition associated with the first cell group, the base station may perform the DCI alignment operation in the first cell in the first cell group, and determine the size of the MC-DCI. This effectively reduces the number of zero bits added in the DCI alignment process, reduces the complexity of blind decoding at the terminal and improves transmission performance of a PDCCH.

Method 3: determining the first size corresponding to the MC-DCI in each format based on a predefined manner, or an indication of signaling sent by the base station side to the terminal.

A method for sending DCI is provided according to an embodiment of the present disclosure provides. Referring to FIG. 7, FIG. 7 is a flowchart showing a method for sending DCI according to an embodiment, in which the method may be performed by a base station, and may include steps as follows.

In step 701, multi-cell downlink control information (MC-DCI) is determined.

In the embodiment of the present disclosure, the MC-DCI is used to schedule data transmission of a plurality of cells, and data transmission of each of the cells corresponds to one PDSCH and/or one PUSCH.

In step 702, the MC-DCI is sent to a terminal based on a first size corresponding to a format of MC-DCI.

In one possible implementation, the base station may send to the terminal a signaling, through which the first size corresponding to the MC-DCI in each format is indicated.

Alternatively, when dynamic switching of the number of cells simultaneously scheduled by the MC-DCI is supported, the base station may send to the terminal the signaling, through which the first size corresponding to the MC-DCI in each format is indicated.

Alternatively, when dynamic switching of the number of the cells simultaneously scheduled by the MC-DCI is not supported, the base station may also send to the terminal the signaling, through which the first size corresponding to the MC-DCI in each format is indicated.

In another possible implementation, the base station side may determine the first size corresponding to the MC-DCI in each format based on agreement by a protocol.

Alternatively, when dynamic switching the number of the cells simultaneously scheduled by the MC-DCI is supported, the base station may determine the first size corresponding to the MC-DCI in each format based on agreement by the protocol.

Alternatively, when dynamic switching of the number of the cells simultaneously scheduled by the MC-DCI is not supported, the base station may also determine the first size corresponding to the MC-DCI in each format based on agreement by the protocol.

In the embodiment of the present disclosure, performing the alignment operation means that the base station aligns, for the MC-DCI, the size before MC-DCI alignment with the size after MC-DCI alignment, i.e., the first size corresponding to the format of the MC-DCI, through zero padding or other means such as length truncation.

In the embodiment of the present disclosure, the base station performs the DCI alignment operation in the serving cell, and aligns the size before MC-DCI alignment with the first size corresponding to the format of the MC-DCI. In this case, the size of the MC-DCI is required to meet a preset restriction. Indeed, the preset restriction may be a 3+1 or 4+1 restriction, or other DCI size restriction agreed by the protocol, which is not limited by the present disclosure.

In the above embodiment, by reducing the number of sizes of the MC-DCI in the same format, the number of zero bits added in the DCI alignment process is reduced, complexity of blind decoding at the terminal is lowered, and the transmission performance of the PDCCH is improved.

It can be understood that in the present disclosure, the MC-DCI in each format may correspond to a type of first size, and the MC-DCI in each format may correspond to two or more types of first sizes, which should also be within the protection scope of the present disclosure.

In some alternative embodiments, in a case where dynamic switching of the number of cells simultaneously scheduled by the MC-DCI is supported, the number of cells simultaneously scheduled by the MC-DCI may be set to two at most.

In other words, the number of the cells simultaneously scheduled by the MC-DCI may be switched between 1 and 2, to reduce the number of the sizes of the MC-DCI in the same format. This helps eliminate the compromise to PDCCH transmission performance that will occur if excessive zero bits are added during the DCI alignment process to align with the first size.

In some alternative embodiments, in a scenario where the maximum number of cells that can be scheduled by the MC-DCI is Nmax, among all cells that can be scheduled by the MC-DCI, each of the cells may not support SUL characteristics. In other words, when determining the size corresponding to each MC-DCI format, it is unnecessary to consider the SUL characteristics, to reduce the number of the sizes of the MC-DCI in the same format. This helps eliminate the compromise to PDCCH transmission performance that will occur if excessive zero bits are added during the DCI alignment process to align with the first size.

Or, the number of the cells that support the SUL characteristics is set.

In one possible implementation, among all cells that can be scheduled by the MC-DCI, only the cell that receives the MC-DCI supports the SUL characteristics, to reduce the number of the sizes of the MC-DCI in the same format. This helps eliminate the compromise to PDCCH transmission performance that will occur if excessive zero bits are added during the DCI alignment process to align with the first size. In another possible implementation, among all cells that can be scheduled by the MC-DCI, the number of the cells that support the SUL characteristics is less than or equal to 2, to reduce the number of the sizes of the MC-DCI in the same format. This helps eliminate the compromise to PDCCH transmission performance that will occur if excessive zero bits are added during the DCI alignment process to align with the first size.

In the embodiment of the present disclosure, the cells that can be scheduled by the MC-DCI refer to the cells simultaneously scheduled by the MC-DCI, i.e., the plurality of cells scheduled by the MC-DCI in real time. Or, the cells that can be scheduled by the MC-DCI refer to one or more cells scheduled by the MC-DCI at different moments, but not necessarily the cells scheduled by the MC-DCI at a current moment.

In the above embodiment, the size number of the MC-DCI in the same format is reduced, which can enhance the PDCCH transmission performance by avoiding the addition of excessive zero bits during the DCI alignment process to align with the first size.

In some alternative embodiments, the terminal may determine the first size corresponding to the MC-DCI in each format based on an indication of the signaling sent by the base station, or determine the first size corresponding to the MC-DCI in each format based on agreement by the protocol, which is not limited by the present disclosure.

For the base station side, the DCI alignment operation may be performed by zero padding or other means, specifically, the size before MC-DCI alignment may be aligned with the first size after MC-DCI alignment.

In order to facilitate the understanding of the methods for receiving and sending DCI provided by the present disclosure, the above solution is further illustrated as follows.

In embodiment 1, the terminal is a terminal of Rel-18 and subsequent version, the terminal receives DCI, i.e., MC-DCI, for scheduling data transmission of a plurality of cells, and the terminal receives a PDSCH of a plurality of cells or transmits a PUSCH of a plurality of cells based on indication information corresponding to the DCI.

In the related mechanism, the DCI alignment process is based on a configuration of each of the serving cells. In the serving cell, the base station side performs the DCI alignment operation, and the terminal side deduces the DCI alignment operation. The number of types of DCI sizes monitored by the terminal meets a 3+1 restriction. In a case where this mechanism is directly applied to an MC-DCI scenario, the number of DCI bits added by implementing DCI size alignment through zero padding will greatly increase, which compromises PDCCH transmission performance.

In this embodiment, the first resource ranges may be determined in the serving cell, and the base station side performs the DCI alignment operation in each of the first resource ranges. In the first resource range, the terminal deduces the DCI alignment operation and determines a size of the MC-DCI.

In the embodiment of the present disclosure, the DCI size restriction may be “3+1”, i.e., for the terminal in the serving cell, the number of the types of DCI sizes scrambled by C-RNTI configured in the first resource range is no more than 3, and for the terminal in the serving cell, the total number of the types of DCI sizes configured in the first resource range is no more than 4. A DCI size budget restriction may also be “4+1”, or other defined DCI size budget restriction, which is not limited by the present disclosure.

In one possible implementation, the first resource range may be a time domain resource range, and a measurement unit of the time domain resource range may be frame, or slot, or symbol, etc. A time domain resource range may be a segment of consecutive time domain resource, or one or more segments of non-consecutive time domain resources. The time domain resources may be measured with one or more starting time domain positions and the lengths of time domain resources corresponding to each of the starting time domain positions, and may also be measured by a frame identity (ID) set, a slot ID set, or a symbol ID set. The time domain resources may be determined in a predefined manner (i.e., by agreement via the protocol), or be configured by means of signaling sent by a base station.

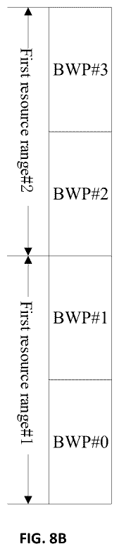

Referring to FIG. 8A, the first resource ranges are defined with a frame starting positions corresponding to even frame IDs as the time domain resource starting positions and the length corresponding to two frames as a length of the time domain resource.

In one possible implementation, the first resource range may be a frequency domain resource range, and a measurement unit of the frequency domain resource range may be a BWP, a resource block (RB), a resource block group (RBG) or a resource element (RE), etc. The frequency domain resource range may be a segment of consecutive frequency domain resource, or one or more segments of non-consecutive frequency domain resources. The frequency domain resources may be measured by one or more starting frequency domain positions plus lengths of frequency domain resources, and may also be measured by a BWP ID set, a RB ID set, or a RE ID set. The frequency domain resources may be determined in a predefined manner, or by means of a signaling configuration.

Referring to FIG. 8B, the first resource ranges are defined by the BWP ID set, in which first resource range #1 includes {BWP #0, BWP #1}, and first resource range #2 includes {BWP #2, BWP #3}.

In this embodiment, by introducing a DCI alignment mechanism within the first resource range in the serving cell, the base station performs the DCI alignment operation based on each of the first resource ranges, thereby effectively reducing the number of the zero bits padded in the MC-DCI and improving the PDCCH transmission performance.

In embodiment 2, the terminal is a terminal of Rel-18 and subsequent version, and the terminal receives DCI (i.e., MC-DCI) for scheduling data transmission of a plurality of cells, and the terminal receives a PDSCH of a plurality of cells or transmits a PUSCH of a plurality of cells based on indication information corresponding to the DCI.

In the related mechanism, the DCI alignment process is based on a configuration of the serving cell. In the serving cell, after a base station side performs the DCI alignment process, a terminal side deduces a DCI alignment operation, and the number of types of DCI sizes monitored by the terminal meets a 3+1 restriction. In a case where this mechanism is directly applied to a MC-DCI scenario, the number of DCI bits added by implementing the DCI size alignment through zero padding will greatly increase, which compromises PDCCH transmission performance.

In this embodiment, for a particular serving cell group, the first condition corresponding to the size of the MC-DCI is set.

In one possible implementation, the first condition may be at least one of the following: the maximum number of cells that can be supported by the MC-DCI for simultaneous scheduling; the number of cells simultaneously scheduled by the MC-DCI; a maximum number of cells that SUL characteristics among a plurality of cells that can be scheduled by the MC-DCI; and the maximum number of cells that do not support the SUL characteristics among the plurality of cells that can be scheduled by the MC-DCI.

In the embodiment of the present disclosure, the cells that can be scheduled by the MC-DCI refer to the cells simultaneously scheduled by the MC-DCI, i.e., the plurality of cells scheduled by the MC-DCI in real time. Or, the cells that can be scheduled by the MC-DCI refer to one or more cells scheduled by the MC-DCI at different moments, but not necessarily the cells scheduled by the MC-DCI at a current moment.

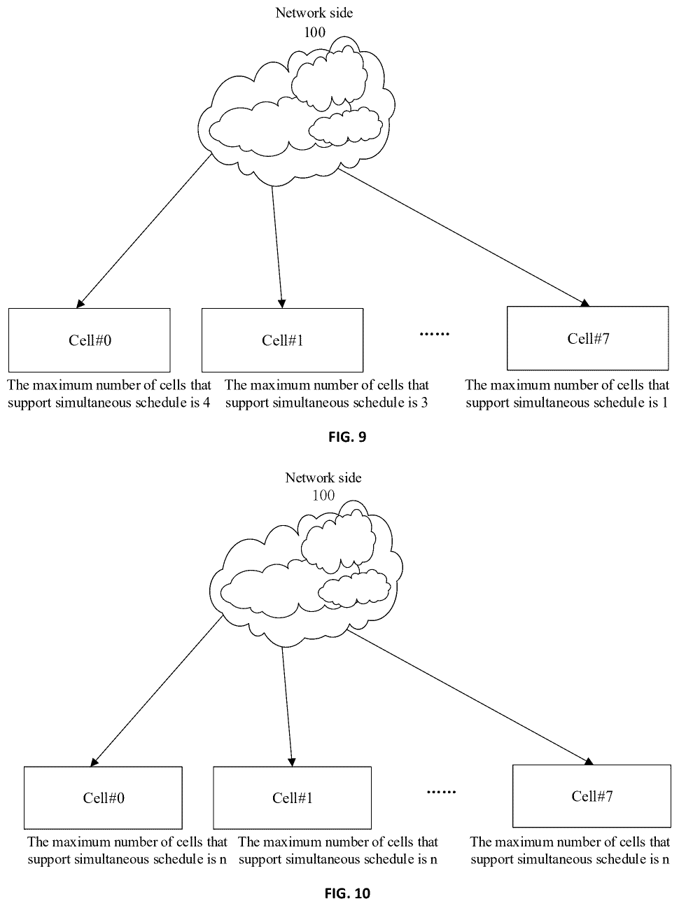

In one possible implementation, different first conditions may be associated with different first cell groups. Referring to FIG. 9, different first conditions may be associated with different first cell groups.

In this case, the first cell group #1 includes cell #0, and the maximum number of the cells supporting simultaneous scheduling is 4; the first cell group #2 includes cell #1, and the maximum number of the cells supporting simultaneous scheduling is 3; and so on.

It should be noted that when the number of cells that are included in the first cell group is multiple, the first cell is the cell with the largest or smallest cell index value in the first cell group.

Based on multiplexing the DCI alignment mechanism in the related technical solution, this embodiment, by setting the configurable first condition of the first cell group, reduces the number of DCI sizes configured in the first cell group, effectively reduces an overhead of DCI blind decoding, and improves the PDCCH transmission performance.

In embodiment 3, the terminal is a terminal of Rel-18 and subsequent version, and the terminal receives DCI (i.e., MC-DCI) for scheduling data transmission of a plurality of cells, and the terminal receives a PDSCH of a plurality of cells or transmits a PUSCH of a plurality of cells based on indication information corresponding to the DCI.

In the related mechanism, the DCI alignment process is based on a configuration of each of the serving cells. In the serving cell, a base station side performs a DCI alignment operation, and a terminal side deduces the DCI alignment operation. The number of types of the DCI sizes monitored by the terminal meets a 3+1 restriction. In a case where this mechanism is directly applied to a MC-DCI scenario, the number of DCI bits added by implementing DCI size alignment through zero padding will greatly increase, which compromises transmission performance of a PDCCH.

In this embodiment, a first size corresponding to the MC-DCI in each format may be determined by means of agreement by a protocol, or by means of a signaling indication by a base station.

In one possible implementation, in a scenario where a maximum number of cells that can be scheduled by the MC-DCI is Nmax, the types of numbers of cells that can be scheduled are set. For example, dynamic switching of at most two types of the numbers of the cells that can be scheduled is supported, i.e., the number of the cells that can be scheduled by the MC-DCI is determined among two alternative numbers of cells at most.

In one possible implementation, in a scenario where the maximum number of the cells that can be scheduled by the MC-DCI is Nmax, for example, all cells in a multi-carrier scheduling scenario do not support SUL characteristics. Or, the cells that support the SUL characteristics are set. For example, only the cell where the DCI is received is set to support the SUL characteristics, and at most two cells are supported to transmit the PUSCH on a SUL.

Referring to FIG. 10, the number of the cells scheduled by the MC-DCI has nothing to do with the serving cell. The number of the cells that can be scheduled by each of Cell #0 to Cell #7 is n, where n is a positive integer.

Based on multiplexing an existing DCI alignment mechanism, this embodiment, by setting the number of the cells that can be scheduled or the number of configured SULs in the serving cell, reduces a number of configured DCI sizes, effectively reduces an overhead of DCI blind decoding, and improves the transmission performance of the PDCCH.

Corresponding to the aforementioned embodiments of implementation method of the applied functions, the embodiments of implementation devices for applying the functions is also provided in the present disclosure.

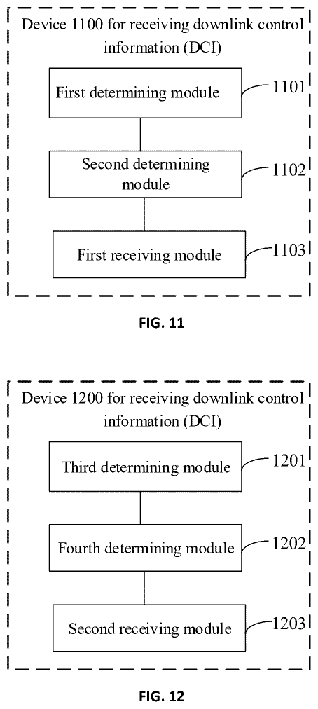

Referring to FIG. 11, FIG. 11 is a block diagram of a device 1100 for receiving downlink control information (DCI) according to an example, where the device is applied to a terminal and includes: a first determining module 1101, configured to determine first resource ranges corresponding to a serving cell; a second determining module 1102, configured to determine a size corresponding to MC-DCI based on a DCI alignment operation performed in each of the first resource ranges; and a first receiving module 1103, configured to receive and parse the MC-DCI based on the size.

Referring to FIG. 12, FIG. 12 is a block diagram of a device 1200 for receiving DCI according to an example, where the device is applied to a terminal and includes: a third determining module 1201, configured to determine a first condition associated with a first cell group, where the first cell group includes at least one cell scheduled by MC-DCI; a fourth determining module 1202, configured to determine, in a case where the MC-DCI meets the first condition, a size of the MC-DCI based on a DCI alignment operation in a first cell in the first cell group; and a second receiving module 1203, configured to receive and parse the MC-DCI in a second cell.

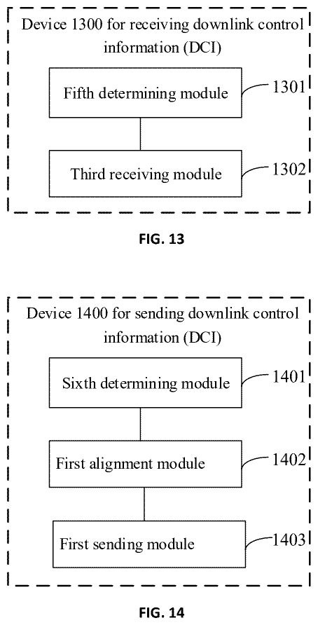

Referring to FIG. 13, FIG. 13 is a block diagram of a device 1300 for receiving DCI according to an example, where the device is applied to a terminal and includes: a fifth determining module 1301, configured to determine a first size corresponding to MC-DCI in each format; and a third receiving module 1302, configured to receive and parse the MC-DCI in a serving cell based on the first size.

Referring to FIG. 14, FIG. 14 is a block diagram of a device 1400 for sending DCI according to an example, where the device is applied to a base station and includes: a sixth determining module 1401, configured to determine first resource ranges corresponding to a serving cell and MC-DCI corresponding to the first resource ranges; a first alignment module 1402, configured to perform a DCI alignment operation in each of the first resource ranges and determine a size of the MC-DCI; and a first sending module 1403, configured to send the MC-DCI to a terminal based on the size.

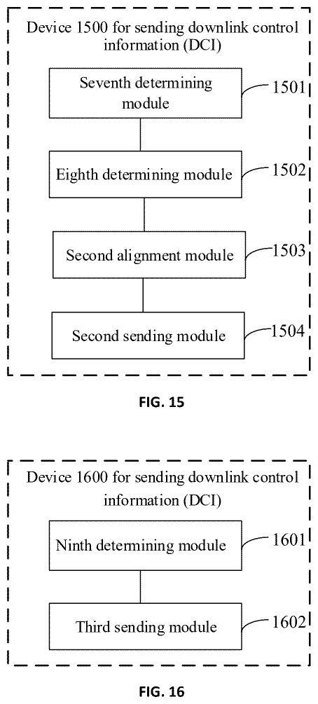

Referring to FIG. 15, FIG. 15 is a block diagram of a device 1500 for sending DCI according to an example, where the device is applied to a base station and includes: a seventh determining module 1501, configured to determine MC-DCI; an eighth determining module 1502, configured to determine a first condition associated with a first cell group, where the first cell group includes at least one cell scheduled by the MC-DCI; a second alignment module 1503, configured to determine, in a case where the MC-DCI meets the first condition, a size of the MC-DCI based on a DCI alignment operation performed by a first cell in the first cell group; and a second sending module 1504, configured to send the MC-DCI to a terminal based on the size.

Referring to FIG. 16, FIG. 16 is a block diagram of a device 1600 for sending DCI according to an example, where the device is applied to a base station and includes: a ninth determining module 1601, configured to determine a first size corresponding to MC-DCI in each format; and a third sending module 1602, configured to send the MC-DCI to a terminal based on the first size corresponding to the MC-DCI in each format.

For the device embodiments, since they substantially correspond to the method embodiments, the relevant part may refer to the relevant part of the method embodiment. The device embodiments described above are merely schematic, in which the units described above as separate components may or may not be physically separated, and the components shown as units may or may not be physical units, i.e., they may be located in one place or distributed over multiple network units. Some or all of the modules may be selected according to actual needs to achieve the purpose of the disclosed solution. Those ordinary skilled in the art can understand and implement it without creative efforts.

Accordingly, a non-transitory computer-readable storage medium is further provided in the present disclosure, where the non-transitory storage medium stores a computer program for performing any of the methods for receiving the DCI at terminal side.

Accordingly, a non-transitory computer-readable storage medium is further provided in the present disclosure, where the non-transitory storage medium stores a computer program for performing any of the methods for sending the DCI at base station side.

Accordingly, a device for receiving DCI is further provided in the present disclosure, including: one or more processors; and a memory that stores processor-executable instructions; where the one or more processors are collectively configured to execute the processor-executable instructions to cause the electronic device to act as the terminal and perform any of the methods for receiving the DCI at terminal side.

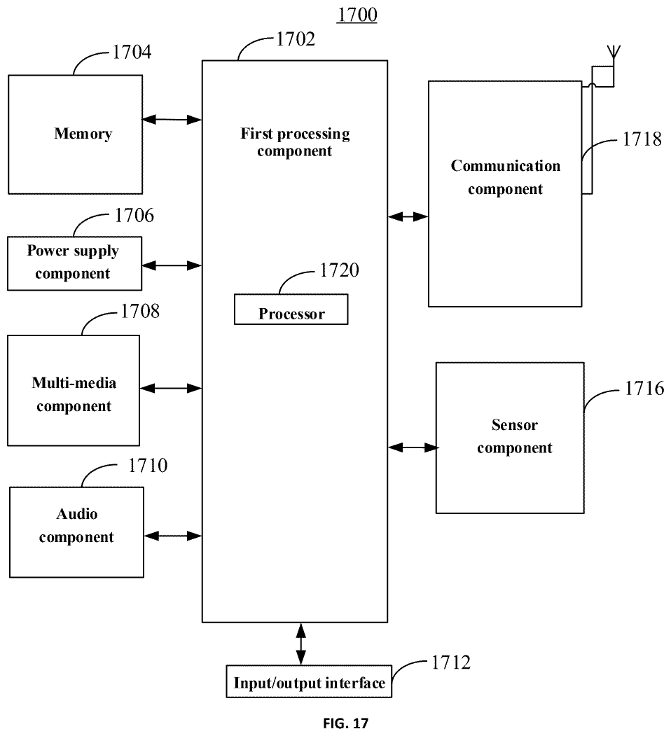

FIG. 17 is a block diagram of a device 1700 for receiving DCI according to an example. For example, the device 1700 for receiving DCI may be a mobile phone, a tablet computer, an e-book reader, a multimedia playing device, a wearable device, a vehicle-mounted user device, an ipad, a smart TV and other terminals.

Referring to FIG. 17, the device 1700 for receiving DCI may include one or more of the following components: a first processing component 1702, a memory 1704, a power supply component 1706, a multimedia component 1708, an audio component 1710, an input/output (I/O) interface 1712, a sensor component 1716, and a communication component 1718.

The first processing component 1702 generally controls an overall operation of the device 1700 for receiving DCI, such as operations associated with display, telephone call, data random access, camera operation and recording operation. The first processing component 1702 may include one or more processors 1720 to execute instructions to accomplish all or some of the steps of the method for receiving the DCI as described above. In addition, the first processing component 1702 may include one or more modules to facilitate interaction between the first processing component 1702 and another component. For example, the first processing component 1702 may include a multimedia module to facilitate interaction between the multimedia component 1708 and the first processing component 1702. For another example, the first processing component 1702 may read the executable instructions from the memory to implement the steps of the method for receiving the DCI as provided by the above embodiments.

The memory 1704 is configured to store various types of data to support operations at the device 1700 for receiving DCI. Examples of such data include instructions for any application or method operating on the device 1700 for receiving DCI, such as contact data, phone book data, messages, pictures, videos, and the like. The memory 1704 can be implemented by any type of volatile or nonvolatile memory device or their combination, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply component 1706 provides power for various components of the device 1700 for receiving DCI. The power supply component 1706 may include a power supply management system, one or more power supplies, and other components associated with generating, managing, and distributing power for the device 1700 for receiving DCI.

The multimedia component 1708 includes a display screen that provides an output interface between the device 1700 for receiving DCI and a user. In some embodiments, the multimedia component 1708 includes a front camera and/or a rear camera. When the device 1700 for receiving DCI is in an operation mode, such as a shooting mode or a video mode, the front camera and/or the rear camera can receive external multimedia data. Each of the front camera and the rear camera can be a fixed optical lens system, or have a focal length and optical zoom capability.

The audio component 1710 is configured to output and/or input audio signals. For example, the audio component 1710 includes a microphone (MIC) configured to receive external audio signals when the device 1700 for receiving DCI is in operation modes, such as a call mode, a recording mode, and a voice recognition mode. The received audio signals may be further stored in the memory 1704 or sent via the communication component 1718. In some embodiments, the audio component 1710 further includes a speaker for outputting audio signals.

The I/O interface 1712 provides an interface between the first processing component 1702 and a peripheral interface module. The above peripheral interface module can be a keyboard, a click wheel, a button, etc. These buttons may include, but are not limited to, a home button, a volume button, a start button, and a lock button.

The sensor component 1716 includes one or more sensors for providing state evaluation of various aspects for the device 1700 for receiving DCI. For example, the sensor component 1716 may detect an on/off state of the device 1700 for receiving DCI, and relative positioning of components, such as the display and a keypad of the device 1700 for receiving DCI. The sensor component 1716 may also detect a change in positions of the device 1700 for receiving DCI or a component of the device 1700 for receiving DCI, the presence or absence of user contact with the device 1700 for receiving DCI, an orientation or acceleration/deceleration of the device 1700 for receiving DCI and a change in temperature of the device 1700 for receiving DCI. The sensor component 1716 may include a proximity sensor configured to detect the presence of a nearby object without any physical contact. The sensor component 1716 may also include an optical sensor, such as a CMOS or CCD image sensor, for use in imaging applications. In some embodiments, the sensor component 1716 may further include an acceleration sensor, a gyro sensor, a magnetic sensor, a pressure sensor, or a temperature sensor.

The communication component 1718 is configured to facilitate wired or wireless communication between the device 1700 for receiving DCI and another device. The device 1700 for receiving DCI may access a wireless network based on communication standards, such as Wi-Fi, 2G, 3G, 4G, 5G or 6G, or their combination. In an example, the communication component 1718 receives a broadcast signal or broadcast related information from an external broadcast management system via a broadcast channel. In an example, the communication component 1718 further includes a near field communication (NFC) module to facilitate short-range communication. For example, the NFC module can be implemented based on a radio frequency identification (RFID) technology, an infrared data association (IrDA) technology, an ultra-wideband (UWB) technology, a Bluetooth (BT) technology and other technologies.

In an example, the device 1700 for receiving DCI can be implemented by one or more of application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements, for performing any of the methods for receiving the DCI at terminal side.

In an example, there is also provided a non-transitory machine-readable storage medium including instructions, such as the memory 1704 including instructions, which may be executed by the processor 1720 of the device 1700 to accomplish the above method for receiving the DCI. For example, the non-transitory computer-readable storage medium can be a ROM, the random-access memory (RAM), a CD-ROM, a magnetic tape, a floppy disk, an optical data storage device, etc.

Accordingly, a device for sending DCI is provided in the present disclosure, including: one or more processors; and a memory that stores processor-executable instructions, where the one or more processors are collectively configured to execute the processor-executable instructions to cause the electronic device to act as the base station and perform any of the methods for sending the DCI at base station side.

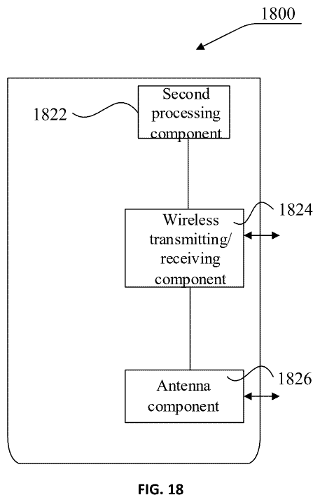

As shown in FIG. 18, FIG. 18 is a structural schematic diagram of a device 1800 for sending DCI according to an example. The device 1800 for sending DCI may be provided as a base station. Referring to FIG. 18, the device 1800 for sending DCI includes a second processing component 1822, a wireless transmitting/receiving component 1824, an antenna component 1826, and a signal processing part specific to the wireless interface, and the second processing component 1822 may further include at least one processor.

One of the processors in the second processing component 1822 may be configured to perform any of the methods for sending the DCI as described above.

An electronic device is further provided according to the present disclosure. The electronic device may be the terminal, the base station and the devices provided in the above description, which is not limited in the present disclosure.

The technical solution provided by the embodiments of the present disclosure can include beneficial effects as follows.

According to the present disclosure, the number of zero bits added in the DCI alignment process can be effectively reduced, the complexity of blind decoding at the terminal is reduced, and the PDCCH transmission performance is improved.

Other implementations of the present disclosure would easily occur to those skilled in the art after considering the specification and practicing the present disclosure disclosed herein. The present disclosure is intended to cover any variations, usages or adaptations of the present disclosure, and such variations, usages or adaptations follow the general principles of the present disclosure and include common sense or common technical means in this technical field that are not disclosed in the present disclosure. The specification and embodiments are regarded as exemplary only, with the scope and spirit of the present disclosure being indicated by the appended claims.

It should be understood that the present disclosure is not limited to the precise structure described above and shown in the accompanying drawings, and various modifications and changes can be made without departing from its scope. The scope of the present disclosure is limited only by the appended claims.

1. A method for receiving downlink control information (DCI), performed by a terminal, comprising:
determining first resource ranges corresponding to a serving cell;
determining a size corresponding to multi-cell downlink control information (MC-DCI) based on a DCI alignment operation performed in each of the first resource ranges; and
receiving and parsing the MC-DCI based on the size.

2. The method according to claim 1, wherein determining the first resource ranges corresponding to the serving cell comprises:
determining the first resource ranges based on at least one starting resource element identity and a number of continuous resource elements corresponding to each starting resource element identity; or
determining the first resource ranges based on a resource element identity set.

3. The method according to claim 2, wherein the resource element identity set comprises at least one of:
a search space (SS) identity;
a bandwidth part (BWP); or
a control resource set (CORESET) identity set.

4. (canceled)

5. The method according to claim 1, wherein the method further comprises at least one of:
the terminal is not expected to determine sizes corresponding to two pieces of the MC-DCI in a same first resource range from the first resource ranges, in a case where the two pieces of the MC-DCI correspond to different formats; or
the terminal is not expected to determine sizes corresponding to two pieces of the MC-DCI in a same first resource range from the first resource ranges, in a case where the two pieces of the MC-DCI correspond to different sizes before DCI alignment operations.

6. A method for receiving downlink control information (DCI), performed by a terminal, comprising:
determining a first condition associated with a first cell group, wherein the first cell group comprises at least one cell scheduled by multi-cell downlink control information (MC-DCI);
determining, in a case where the MC-DCI meets the first condition, a size of the MC-DCI based on a DCI alignment operation in a first cell in the first cell group; and
receiving and parsing the MC-DCI in a second cell based on the size.

7. The method according to claim 6, wherein the first condition is at least one of:
a maximum number of cells supported by the MC-DCI for simultaneous scheduling;
a number of cells simultaneously scheduled by the MC-DCI;
a maximum number of cells that support SUL characteristics among a plurality of cells scheduled by the MC-DCI; and
a maximum number of cells that do not support the SUL characteristics among the plurality of cells scheduled by the MC-DCI.

8. The method according to claim 6, wherein different first conditions are associated with different first cell groups.

9. The method according to claim 6, wherein in a case where a number of the at least one cell comprised in the first cell group is plural, the first cell is a cell with a largest cell index value or a smallest cell index value in the first cell group.

10. The method according to claim 6, further comprising:
determining a first size corresponding to multi-cell downlink control information (MC-DCI) in each format; and
receiving and parsing the MC-DCI in a serving cell based on the first size.

11. The method according to claim 10, wherein there are at most two types of numbers of cells simultaneously scheduled by the MC-DCI in a case where dynamic switching of the number of the cells simultaneously scheduled by the MC-DCI is supported.

12. The method according to claim 10, wherein all cells scheduled by the MC-DCI do not support SUL characteristics;
only a cell, among all the cells scheduled by the MC-DCI, that receives the MC-DCI supports the SUL characteristics; or
a number of cells that support the SUL characteristics among all the cells scheduled by the MC-DCI is less than or equal to two.

13. The method according to claim 10, wherein determining the first size corresponding to the MC-DCI in each format comprises:
determining the first size corresponding to the MC-DCI in each format based on an indication of signaling sent by a base station; or
determining the first size corresponding to the MC-DCI in each format based on agreement by a protocol.

14. A method for sending downlink control information (DCI), performed by a base station, comprising:
determining first resource ranges corresponding to a serving cell and multi-cell downlink control information (MC-DCI) corresponding to the first resource ranges;
performing a DCI alignment operation in each of the first resource ranges and determining a size of the MC-DCI; and
sending the MC-DCI to a terminal based on the size.

15. The method according to claim 14, wherein determining the first resource ranges corresponding to the serving cell comprises:
determining the first resource ranges based on at least one starting resource element identity and a number of continuous resource elements corresponding to each starting resource element identity; or
determining the first resource ranges based on a resource element identity set.

16. The method according to claim 15, wherein the resource element identity set comprises at least one of:
a search space (SS) identity set;
a bandwidth part (BWP) identity set; or
a control resource set (CORESET) identity set.

17. (canceled)

18. The method according to claim 14, wherein the method further comprises:
performing, by the base station, DCI alignment operations on two pieces of the MC-DCI respectively in different first resource ranges, in a case where the two pieces of the MC-DCI correspond to different formats; or
performing, by the base station, DCI alignment operations on two pieces of the MC-DCI respectively in different first resource ranges, in a case where the two pieces of the MC-DCI correspond to different sizes before the DCI alignment operations.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A non-transitory computer-readable storage medium storing a computer program, wherein the computer program is configured to implement the method for receiving the downlink control information (DCI) according to claim 1.

35. A non-transitory computer-readable storage medium storing a computer program, wherein the computer program is configured to implement the method for sending the downlink control information (DCI) according to claim 14.

36. An electronic device, comprising:
one or more processors; and
a memory that stores processor-executable instructions,
wherein the one or more processors are collectively configured to execute the processor-executable instructions to cause the electronic device to act as the terminal and perform the method for receiving the downlink control information (DCI) according to claim 1.

37. An electronic device, comprising:
one or more processors; and
a memory that stores processor-executable instructions,
wherein the one or more processors are collectively configured to execute the processor-executable instructions to cause the electronic device to act as the base station and perform the method for sending the downlink control information (DCI) according to claim 14.
